(19) United States
(12) Patent Application Publication
(10) Pub. No.: US 2023/0058250 A1
(43) Pub. Date: Feb. 23, 2023

(54) REFRACTORY MATERIALS AND METHODS OF MANUFACTURE THEREOF

(71) Applicant: University of Exeter, Exeter Devon (GB)

(72) Inventor: Shaowei ZHANG, Exeter Devon (GB)

(21) Appl. No.: 17/784,087

(22) PCT Filed: Dec. 9, 2020
(86) PCT No.: PCT/EP2020/085274

§ 371 Date: Jun. 9, 2022

(30) Foreign Application Priority Data
Dec. 12, 2019 (GB) 1918303.7

(51) Int. Cl. C04B 35/628

(52) U.S. Cl. CPC C04B 35/62821; C04B 35/62823; C04B 2111/00431

(57) ABSTRACT

A method for forming a refractory material is described comprising the steps of placing a core material 12 into a granulator device 16, operating the granulator device 16 to form the core material into granules 16, adding a coating material 18 to the granulator device 16, operating the granulator device 16 to result in the formation of a layer 20 of the coating material 18 encapsulating the granules 16, and then heating the coated granules 22. Materials manufactured using the method are also described.

This invention relates to refractory materials, for example for use in the steel and other industries, and to methods of manufacture thereof.

The use of refractory materials in the production of steel is widespread, the use of the materials being advantageous in that they allow the removal of non-metallic inclusions from the steel, resulting in a higher quality end product.

Calcium oxide based materials are thought to perform well as refractory materials for use in such applications as they allow the absorption and removal of sulphur and phosphor containing materials from molten steel. However, the use of calcium oxide based materials is hampered in that they suffer from rapid hydration, making it difficult to manufacture, store and transport the materials.

Attempts have been made to provide calcium oxide based materials for use in such applications with a coating or the like to reduce hydration thereof, or to otherwise treat them to result in the materials being less susceptible to hydration. By way of example, techniques are known that involve preparing the materials under very high temperatures to result in the materials being of reduced surface reactivity and porosity. However such a technique is very energy intensive and expensive, and accordingly is of limited use. Furthermore, the treated or processed materials still hydrate relatively rapidly, and so the use of the technique is of limited benefit. Another technique involves applying a coating to the materials to render them less susceptible to hydration. However, it has been found that relatively thick coatings are required to achieve the required impact upon hydration, and if the coating becomes damaged then the benefits of applying the coating are impaired. Accordingly, such techniques are thought to be unsuitable for use at an industrial scale.

Whilst hydration represents one known issue with refractory materials, other issues include material cost and the like, resulting in increased operating expense when undertaking processing of steel and the like.

It is an object of the invention to provide a method for use in the manufacture of a refractory material, and a material manufactured using the method, in which at least some of the disadvantages associated with known methods are overcome or are of reduced effect.

According to the present invention there is provided a method for forming a refractory material comprising the steps of placing a core material into a granulator device, operating the granulator device to form the core material into granules, adding a coating material to the granulator device, operating the granulator device to result in the formation of a layer of the coating material encapsulating the granules, and then heating the coated granules.

The core material may comprise a calcium oxide based material such as CaO or Doloma. The coating material may comprise, for example, a material that, once applied to the core material, reduces hydration thereof. By way of example, the coating material may comprise CaZrO₂, CaTiO₃, or a mixture of ZrO₂ with CaO, or a mixture of TiO₂ with CaO. However, it will be appreciated that these represent merely example materials that may be used. Alternatively, the coating layer may be of a material that resists or reduces corrosion of the core material.

Whilst one application of the invention is in the formation of refractory materials in which hydration thereof is reduced, another application is in the formation of refractory materials of reduced cost. In such an arrangement, the coating material may comprise a calcium oxide based material of relatively high quality applied to a core of a different material, such as a calcium oxide based material of lower quality. As it is largely the outer part of the refractory material that, in use, serves to absorb and separate materials from steel, during processing of steel, the use of the invention allows refractory materials of a desired size to be made primarily from a relatively low cost, lower quality material, using only the higher quality, higher cost material where it is required to achieve a desired level of functionality. If desired, a refractory material formed in this manner may have a layer of a second coating material applied thereto, for example a coating material of the type mentioned hereinbefore that serves to reduce hydration of the refractory material.

By way of example, the coating material may be of substantially the same material as the core material, but of a higher grade or purity than the core material. Examples include the use of a high grade, high purity magnesite as the coating material, covering a core material of a lower grade, lower purity magnesite, the use of alumina as the coating material, covering a core material of bauxite, the use of bauxite as the coating material, covering a core material of clay, the use of relatively high purity clay as the coating material to cover a core material of a relatively low purity clay, and the use of relatively high purity bauxite as the coating material to cover a core material of a relatively low purity bauxite.

Alternatively, the coating material and the core material may be of dissimilar materials, using a better material for the coating material and a poorer material for the core material. The core material could be of recycled form, for example in the form of used lining materials and/or industry wastes such as Al-dross and red mud. Examples of suitable materials to use include magnesite for the coating material and forsterite for the core material, magnesium aluminate spinel as the coating material covering a core of alumina, and zirconia as a coating material covering a core of an alumina core material.

It will be appreciated that these merely represent examples of suitable combinations of materials.

The invention further relates to a product manufactured using the afore described method, the product comprising a core of a first material to which a coating layer of a second material is bonded.

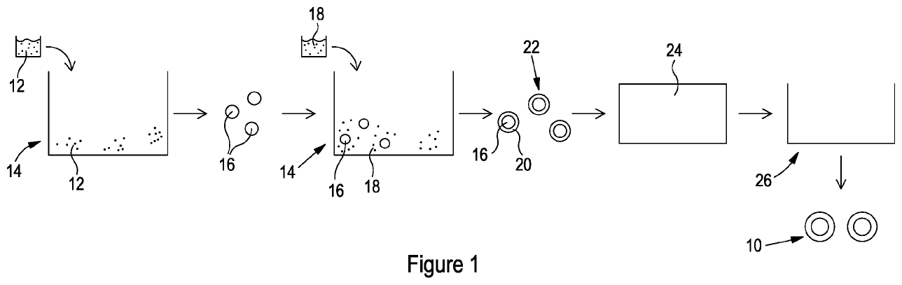

The invention will further be described, by way of example, with reference to the accompanying drawing, FIG. 1, which is a diagrammatic view illustrating steps in the method for manufacture of a refractory material in accordance with an embodiment of the invention.

As illustrated in FIG. 1, a refractory material 10 is formed by applying a core material 12 to a granulator device 14 to form the core material into core granules 16 of a desired size. By way of example, the granulator device 14 may take the form of a disc/pan or drum granulator. The core material 12 may comprise a calcium oxide based material such as CaO or Doloma, together with suitable binder and/or plasticiser materials to result in the formation of calcium oxide based material core granules 16 of a desired size. The core granules may be of, for example 4-8 mm diameter. However, it will be appreciated that the invention is not restricted in this regard, and the core granules 16 may be smaller or larger than this.

After formation of the core granules 16, a coating material 18 is added to the granulator device 14, and operation of the granulator device 16 takes place to apply a coating layer 20 to each of the core granules 16, resulting in the formation of coated granules 22. The operation of the granulator device 16 continues until a desired coating thickness have been achieved. By way of example, the coating may be of thickness in the region of 1-2 mm, but it will be appreciated that the invention is not restricted in this regard and thicker or thinner coating layers may be applied depending upon the application in which the material is to be used and the requirements thereof.

The coating material 18 may take a range of forms. By way of example, in the arrangement illustrated the coating material is intended to result in the formation of a coating layer that results in the finished refractory material being less susceptible to hydration, and the material is chosen accordingly. The coating material 18 may thus take the form of, for example, CaZrO₃, CaTiO₃, a mixture of ZrO₂ and CaO or a mixture of TiO₂ and CaO. These materials are chosen as they are non-hydratable high melting point oxides compatible with CaO. It will be appreciated, however, that other materials may be used without departing from the scope of the invention, and that the invention is not restricted in this regard.

After formation of the coated granules 22, the coated granules 22 are removed from the granulator device 14 and a placed within an oven 24 to dry the coated granules 22. After drying, the coated granules 22 are placed into a ceramic saggar 26 or the like and are sintered at high temperature for a desired period of time to increase the density of the granules and to result in the formation of the final refractory material 10. As shown in FIG. 1, the refractory material 10 includes a core of a calcium oxide based material which is provided with a coating layer that is of a non-hydratable material, protecting the core from hydration.

It will be appreciated that by appropriate control over the operating parameters of the granulator device, the sizes of the cores and the thicknesses of the applied coating layers may be accurately controlled. By way of example, controlling the amounts and sizes of materials added to the granulator device, the operating speed of the granulator device, the duration over which the granulator device is operated, and the quantity and nature of any plasticisers or other additives included with the materials can be used to control the granule and layer sizes and thicknesses.

By manufacture of the refractory material in this manner, a relatively dense anti-hydration layer is applied to a calcium oxide based material core. It is well bonded to the core, and so the risk of loss of part of the layer, with the attendant risk of hydration of the core occurring is reduced.

The size of the granules, and the thickness of the layer can be accurately controlled, by appropriate control over the operation of the granulator device. As a result, the method lends itself to operation at an industrial scale.

As there may be a difference in the thermal expansion characteristics of the core and the applied coating layer, care should be taken during the sintering operation to avoid the formation of cracks or the like in the cores, coating layers and at the interface therebetween.

Whilst in the arrangement described hereinbefore, the method is used to apply an anti-hydration coating layer to a granule, this represents merely one application of the invention. In another application, the core granules 16 may be of a relatively low grade of a calcium oxide based material, and the coating layer 20 may be of a higher grade of a calcium oxide based material. In this manner, the invention permits the formation of refractory materials 10 having an outer surface of a relatively expensive, high grade material, but the use of a lower grade material for the core allows significant cost savings to be made. As it is primarily the grade of the outer part of the material that determines how it performs, these cost savings can be obtained without significantly impacting upon the performance of the materials.

The same method could be used with other materials. By way of example, materials including a clay (low grade) core and a bauxite and mullite (medium grade) or pure alumina (higher grade) coating layer may be produced, or materials having a low grade Magnesite core, and a low grade forsterite or a higher grade pure magnesite coating layer may be produced. Other options including providing materials with a low grade zircon core and a higher grade zirconia coating layer, or a low grade Doloma core and a higher grade Doloma coating layer. It will be appreciated that these represent merely examples of materials with which the invention may be employed.

The coating material may be of substantially the same material as the core material, but of a higher grade or purity than the core material. Examples include the use of a high grade, high purity magnesite as the coating material, covering a core material of a lower grade, lower purity magnesite, the use of alumina as the coating material, covering a core material of bauxite, the use of bauxite as the coating material, covering a core material of clay, the use of relatively high purity clay as the coating material to cover a core material of a relatively low purity clay, and the use of relatively high purity bauxite as the coating material to cover a core material of a relatively low purity bauxite.

Alternatively, the coating material and the core material may be of dissimilar materials, using a better material for the coating material and a poorer material for the core material. The core material could be of recycled form, for example in the form of used lining materials and/or industry wastes such as Al-dross and red mud. Examples of suitable materials to use include magnesite for the coating material and forsterite for the core material, magnesium aluminate spinel as the coating material covering a core of alumina, and zirconia as a coating material covering a core of an alumina core material.

It will be appreciated that these merely represent examples of suitable combinations of materials.

If desired, a material manufactured in the manner set out above may have one or more additional coating layers applied thereto using the method described hereinbefore.

Accordingly, a relatively low cost, high grade product may be produced, which has the benefit of including, for example, an anti-hydration coating layer or an anti-corrosion coating layer.

Whilst specific embodiments of the invention are described hereinbefore, it will be appreciated that a wide range of modifications and alterations may be made thereto without departing from the scope of the invention as defined by the appended claims.

1. A method for forming a refractory material comprising the steps of placing a core material into a granulator device, operating the granulator device to form the core material into granules, adding a coating material to the granulator device, operating the granulator device to result in the formation of a layer of the coating material encapsulating the granules, and then heating the coated granules.

2. A method according to claim 1, wherein the core material and the coating material are of different grades of the same material, the coating material being of a higher grade than the core material.

3. A method according to claim 1, wherein the core material and the coating material are of dissimilar materials.

4. A method according to claim 1, wherein the core material comprises a calcium oxide based material.

5. A method according to claim 4, wherein the core material comprises CaO or Doloma.

6. A method according to any of the preceding claims, wherein the coating material comprises a material that, once applied to the core material, reduces hydration thereof.

7. A method according to claim 6, wherein the coating material comprises one of CaZrO₂, CaTiO₃, a mixture of ZrO₂ with CaO, and a mixture of TiO₂ with CaO.

8. A method according to claim 1, wherein the coating material comprises a material of relatively high quality applied to a core of a different material.

9. A method according to claim 8, wherein the coating material comprises a high grade calcium oxide based material, and the core is of a calcium oxide based material of lower quality or grade.

10. A method according to claim 8, wherein the core is of a clay (low grade) and the coating material is of a bauxite and mullite (medium grade) or pure alumina (higher grade), or the core is of a low grade Magnesite core, and the coating layer is of a low grade forsterite or a higher grade pure magnesite, or the core is of a low grade zirconia core and the coating layer is of a higher grade zirconia, of the core is of a low grade Doloma and the coating layer is of a higher grade Doloma.

11. A refractory material manufactured according to the method of any of the preceding claims, the refractory material comprising a core of a first material to which a coating layer of a second material is bonded.
